(19) United States
(12) Patent Application Publication
(10) Pub. No.: US 2006/0106624 A1
(43) Pub. Date: May 18, 2006

(54) System and method for providing home remodeling services

(76) Inventors: Bert A. Hardin, Marietta, GA (US); James A. Cory III, Marietta, GA (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 10/987,355

(22) Filed: Nov. 12, 2004

(51) Int. Cl. G06Q 99/00

(52) U.S. Cl. 705/1

(57) ABSTRACT

A system for providing home remodeling comprising at least one computer connected to a network, and at least one database connected to the network, wherein the at least one database comprises approved contractors, approved homeowners, projects submitted by the approved homeowners, and bids for projects, wherein the bids are placed by the contractors. An engineering firm administers and warrants work provided by contractors to homeowners, wherein the engineering firm provides contractors with code requirement and building permit guidance, and a facility for material installation procedure searching.

### COPYRIGHT NOTICE AND LIMITED AUTHORIZATION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present invention relates generally to systems and methods for managing construction, and more specifically to a system and method for providing home remodeling services, wherein contractors and homeowners contract through and are approved by a managing engineering firm, and wherein the contractor's work is warranted by, and performed under specifications from, the managing engineering firm.

### BACKGROUND OF THE INVENTION

There are a multitude of complaints filed every year against contractors by homeowners who have contracted for home remodeling services. Because most states do not stringently regulate home remodeling, unqualified and/or unscrupulous contractors may undertake the remodeling of a home. Such contractors often lack engineering skills, may not be familiar with building codes and standards, and may not have experience in the proper installation of building materials.

In addition to inexperience in materials application, unscrupulous contractors have been known to “cut corners” to save labor and materials, and, as such, often elect to forego the installation of materials according to the material manufacturer's specifications and installation instructions.

For the aforementioned reasons, home remodeling literature recommends that homeowners learn as much about a contractor prior to selecting same to undertake a home remodeling project. Unfortunately, when contemplating home remodeling, homeowners who wish to make an informed judgment on the selection of a contractor typically only have at their disposal those references provided by the contractor, wherein such references are often selected by the contractor from those he believes will be favorable.

Moreover, many contractors do not provide a warranty for their work, thus leaving and the homeowner completely on his/her own in attempting to recover for defective and/or improper workmanship. As a result, the contracting industry as a whole suffers and ethical contractors pay a price for the shoddy work of their less professional colleagues.

Therefore, it is readily apparent that there is a need for a system and method for providing home remodeling services to ensure code and building permit compliance, safety compliance, and validity and enforceability of manufacturer warranties.

### BRIEF SUMMRY OF THE INVENTION

Briefly described, in a preferred embodiment, the present invention overcomes the above-mentioned disadvantages and meets the recognized need for such an invention by providing a system and method for the provision of home remodeling services, wherein contractors and homeowners are both pre-approved by a managing engineering firm. The managing engineering firm screens contractors for appropriate insurance and license, and further provides a database and access portal on a network, such as a global networking system (i.e., the Internet) and/or intranet, for secure posting of projects by homeowners and bidding on projects by contractors. Additionally, the managing engineering firm provides guidance to the contractors and homeowners in the form of engineering knowledge, building permit and code requirement information, and a home warranty.

According to its major aspects and broadly stated, the present invention in its preferred form is a system and method for providing home remodeling services, wherein the homeowner is protected by utilizing pre-qualified contractors acting under the supervision of an engineering firm, and wherein the homeowner receives a warranty backed by the engineering firm, with repairs conducted by the selected contractor in accordance therewith.

More specifically, the present invention is a system and method for providing home remodeling services, wherein contractors are screened by the managing engineering firm to ensure that only contractors with experience appropriate to selected categories of work are approved. Additionally, the managing engineering firm ensures that the appropriately licensed, adequately bonded, and/or adequately insured contractor is selected for the scope and scale of project to be undertaken. Finally, in depth background checks on the contractors are performed by contacting business references, professional associations, complaint bureaus, financial and longevity references, and by further seeking references from homeowners for whom the contractor has performed work.

Similarly, homeowners are screened for creditworthiness via credit bureaus and the like. Homeowner's projects are screened for suitability based on the contractors available, wherein engineering services can be provided where the scope of the project is beyond that of traditional contractors.

The managing engineering firm provides the skills and knowledge of building codes and standards for the contractors' and homeowners' reference, and further provides the homeowners and contractors with benchmarks and checklists to ensure that informed communication takes place.

Briefly, the warranty requires two steps for validation:

1. Once the homeowner has selected a contractor, the homeowner completes the warranty validation form, thereby approving the selected contractor for the home remodeling project.

2. After completion of the project, the contractor signs an affidavit that all work has been performed according to code and manufacturers' standards, and that all subcontractors have been paid. Subsequently, the homeowner affirms approval of the work performed and submits a copy of the final warranty certificate to the managing engineering firm and retains the original.

Accordingly, a feature and advantage of the present invention is its ability to ensure that manufacturer's instructions are complied with, thereby ensuring warranty applicability, validity and enforceability.

Another feature and advantage of the present invention is its ability to ensure that work has been performed to local, state and/or municipal code standards.

Still another feature and advantage of the present invention is its ability to facilitate building permit approvals.

Yet another feature and advantage of the present invention is that it provides warranted services to homeowners.

Yet still another feature and advantage of the present invention is its ability to assist a contractor in meeting code, safety and ethical standards.

A further feature and advantage of the present invention is it ensures that only qualified contractors perform home remodeling work.

Yet another feature and advantage of the present invention is its validation and approval of homeowner credit, thereby ensuring that payment is made to the contractor.

Still yet another feature and advantage of the present invention is its ability to provide contractors and homeowners with guidance for a project.

An additional feature and advantage of the present invention is that it enhances consumer confidence in the home remodeling industry.

Still an additional feature and advantage of the present invention is its ability to reduce the likelihood of litigation between contractors and homeowners.

Yet an additional feature and advantage of the present invention is that defects in workmanship are rapidly remedied at no cost to the homeowner.

These and other features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Selected Alternate Embodiments with reference to the accompanying drawing figures, in which like reference numerals denote similar structure and refer to like elements throughout, and in which:

FIG. 1 is a layout diagram of a system and method for providing home remodeling services according to a preferred embodiment of the present invention;

FIG. 2 is a flowchart of the contractor approval process of a system and method for providing home remodeling services according to a preferred embodiment of the present invention;

FIG. 3 is a flowchart of the homeowner approval process of a system and method for providing home remodeling services according to a preferred embodiment of the present invention;

FIG. 4 is a flowchart of the project phase of a system and method for providing home remodeling services according to a preferred embodiment of the present invention;

FIG. 5 is a flowchart of the warranty complaint process of a system and method for providing home remodeling services according to a preferred embodiment of the present invention;

FIG. 6 is a warranty validation form of a system and method for providing home remodeling services according to a preferred embodiment of the present invention; and

FIG. 7 is a final warranty certificate of a system and method for providing home remodeling services according to a preferred embodiment of the present invention.

### DETAILED DESCRIPTION OF THE PREFERRED AND SELECTED ALTERNATIVE EMBODIMENTS

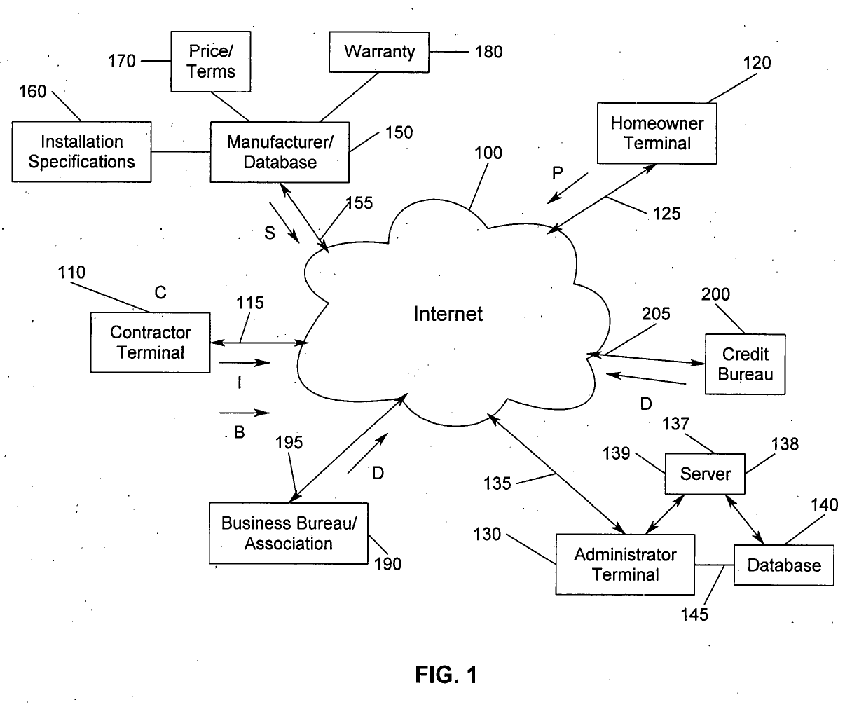

In describing the preferred and selected alternate embodiments of the present invention, as illustrated in FIGS. 1-7, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIGS. 1-7, the present invention in a preferred embodiment is a system and method for providing home remodeling services, wherein operating system 10 comprises Internet 100, contractor computer system 110, homeowner computer system 120, administrator computer system 130, administrator database 140, and manufacturer database 150. Administrator computer system 130 comprises server 137, web site 138, and search engine 139, wherein search engine 139 is tuned to locate and obtain manufacturer specifications. Manufacturer database 150 comprises installation specifications 160, prices/terms 170, and product warranty information 180. Contractor computer system 110, homeowner computer system 120, administrator computer system 130 and manufacturer database 150 are in electrical communication with Internet 100 via connections 115, 125, 135 and 155, respectively. Administrator computer system 130 and administrator database 140 are in electrical communication with one another via connection 145, wherein administrator database 140 can be securely accessed from Internet 100 via connections 135 and 145. Business bureau/association 190 and credit bureau 200 are in electrical communication with Internet 100 via connections 195 and 205, respectively.

In operation, administrator A at administrator computer system 130 can selectively access data report D at business bureau/association 190 and/or credit bureau 200, wherein data report D is preferably utilized to provide administrator A with the ability to assess business skills and ethics of contractor C and creditworthiness of homeowner H. Homeowner H, utilizing computer system 120, and contractor C, utilizing computer system 110, communicate via Internet 100 with administrator A, utilizing computer system 130, wherein contractor C and homeowner H provide administrator A with additional information I for utilization by administrator A in selectively approving contractor C and homeowner H for inclusion in administrator database 140. Once approved and included in administrator database 140, homeowner H can post projects P for contractors C to submit bids B therefor.

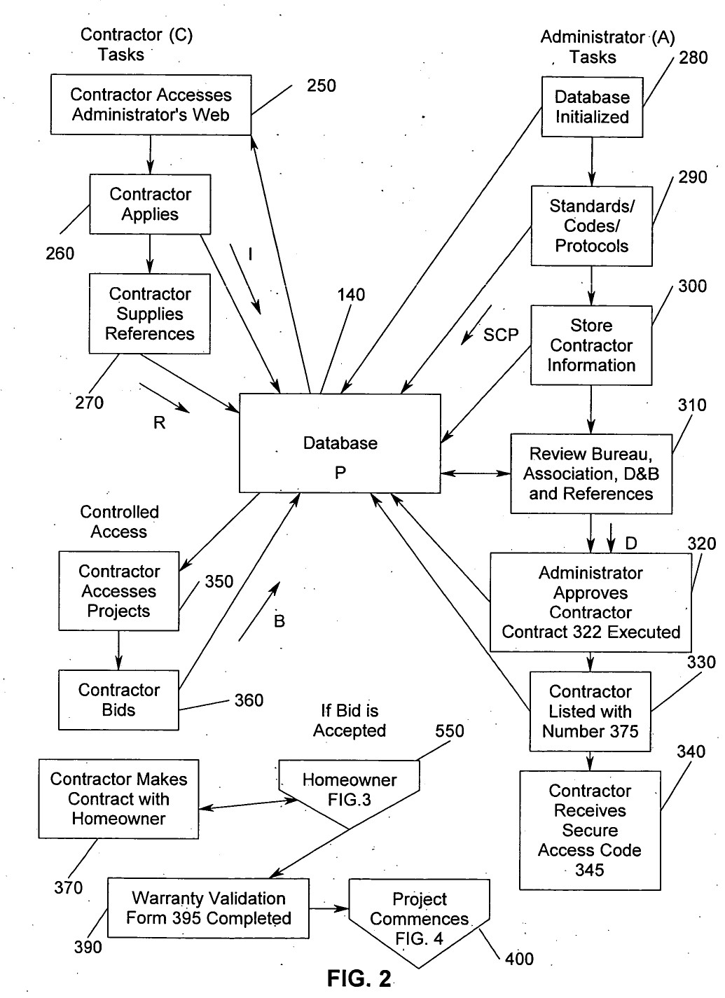

Referring now more specifically to FIGS. 1 and 2, administrator A initializes database 140 in step 280, installing standards, codes and protocols SCP on database 140 in step 290, receives contractor information I (as set forth more fully hereinbelow), and subsequently stores contractor information I on database 140, wherein contractor information I comprises financial history of contractor C, insurance coverage, such as, for exemplary purposes only, liability insurance, property damage insurance and worker's compensation insurance, and the like. For instance, contractor C accesses Internet 100 in step 250, wherein web site 138 of administrator A provides contractor C with the ability to submit information I in order to be considered for approval for inclusion within administrator database 140. Web site 138 will be located on server 137, wherein administrator computer system 130 preferably comprises server 137. It will be recognized by those skilled in the art that web site 138 on server 137 could be located anywhere so long as server 137 is accessible via Internet 100. Upon reviewing web site 138, contractor C applies for inclusion in database 140 via steps 260 and 270, providing information I, including references R, to database 140, wherein administrator A utilizes information I to selectively approve contractor C for inclusion within database 140.

Administrator A obtains data D from business bureau/association 190 via Internet 100 in step 310, wherein data D comprises, for exemplary purposes only, financial information and/or complaint information. Administrator A reviews information I, references R and data D, and selectively chooses to include contractor C within database 140, approving contractor C in step 320, wherein contractor C and administrator A execute contract 322, wherein contract 322 comprises an agreement between administrator A and contractor C.

For instance, contract 322 may comprise, for exemplary purposes only, provisions relating to the responsibilities of administrator A, scope of services to be provided by administrator A, scope of inspection services to be performed by administrator A, services of administrator A as an expert witness, acceptance by contractor C of payment of legal fees, prohibition of administrator A participating in bidding and negotiation phase, exclusion of a requirement of design services by administrator A, exclusion of the preparation or administration of construction documents by administrator A, and a requirement of contractor C to assist in completion of warranty validation form 395 and final warranty certificate 625; however, it should be recognized that any applicable provision may be incorporated into contract 322.

Once contractor C has been approved, administrator A lists contractor C on web site 138 in step 330, and provides contractor C with secure access code 345 in step 340. It is envisioned that secure access code 345 could comprise alphanumeric groupings indicative of a specific field of services, training and/or experience held by contractor C.

Once approved, contractor C can selectively access project P on database 140 via step 350 using secure access code 345, wherein contractor C selectively places bid B on database 140 in step 360, in response to selected project P.

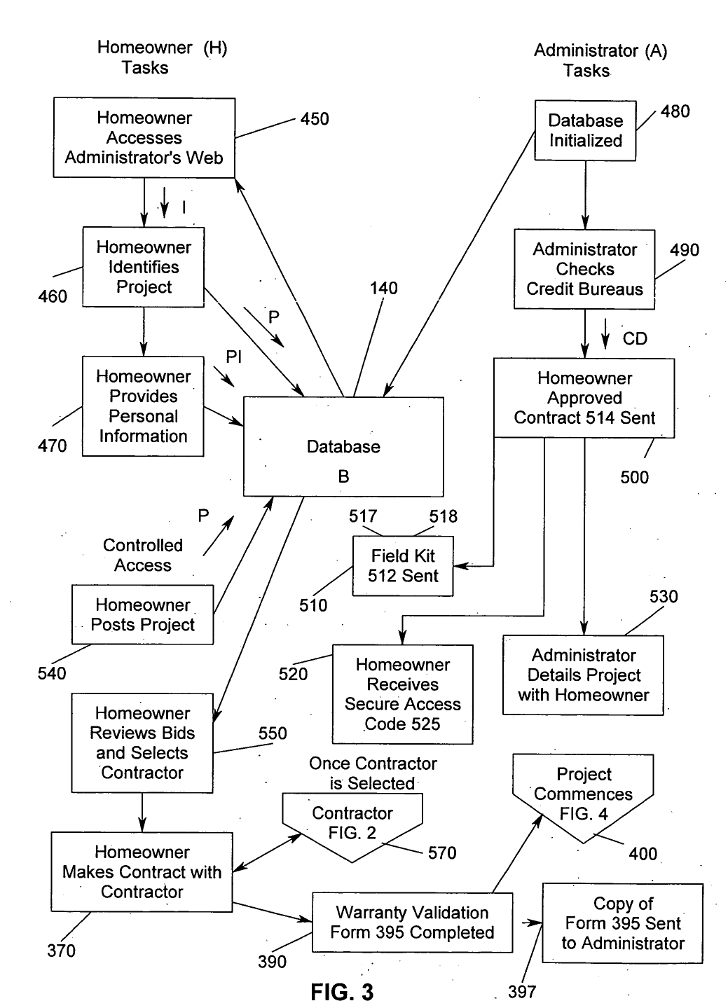

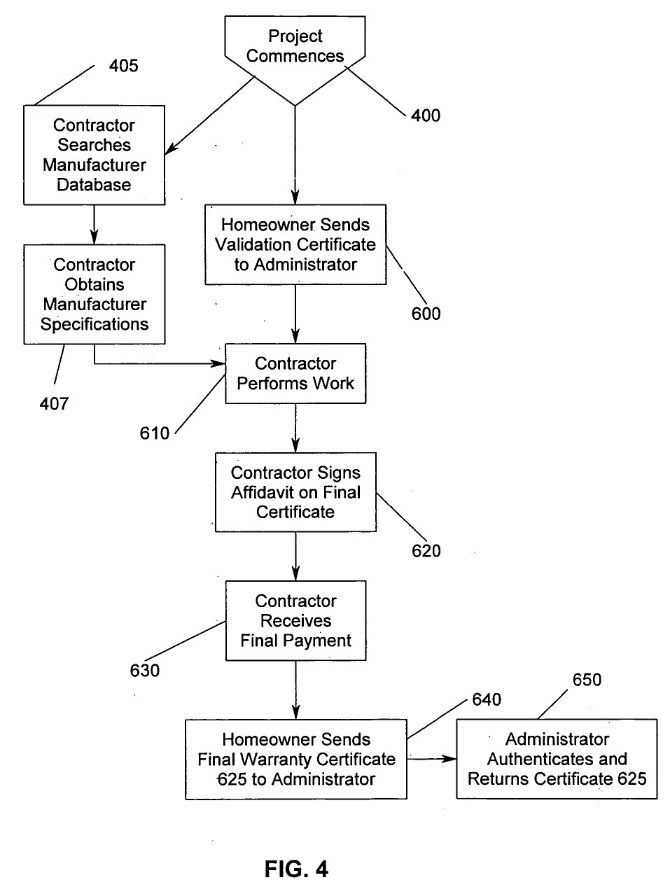

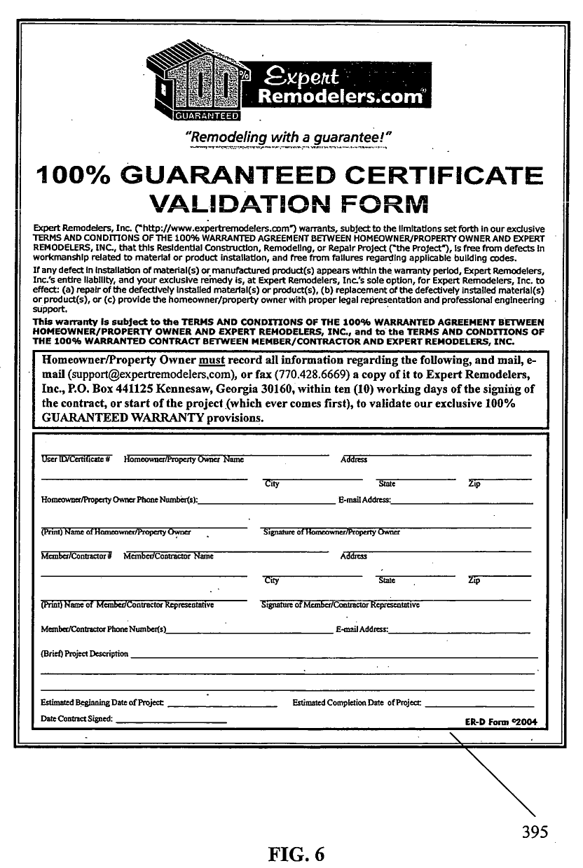

If homeowner H, via homeowner selection process 550 (best shown in detail in FIG. 3) chooses contractor C for project P, contractor C agrees with homeowner H in step 370 to undertake project P. Upon selecting contractor C, homeowner H completes warranty validation form 395 (best shown in FIG. 6) via step 390, including contractor number 375 thereon and project P commences via process 400 (as best shown in FIG. 4).

Referring now more specifically to FIGS. 1 and 3, subsequent to administrator A initializing database 140 via step 480, homeowner H accesses web site 138 of administrator A via step 450 and specifies desired project P to administrator A via step 460. Homeowner provides personal information PI to database 140 of administrator A via step 470, wherein administrator A further obtains credit data CD via step 490 and approves or declines homeowner H via step 500. If homeowner H is not approved, the process ends for that homeowner H. If homeowner H is approved, homeowner H posts project via step 540 homeowner H reviews bids and selects contractor C, and homeowner H and contractor C execute contract 514, wherein contract 514 comprises an agreement between homeowner H and contractor C.

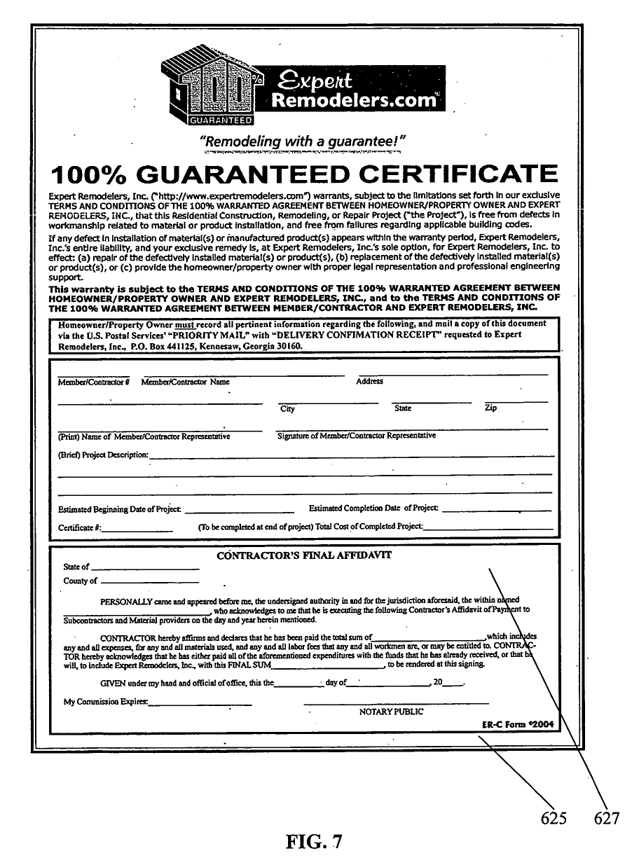

For instance, contract 514 may comprise, for exemplary purposes only, provisions relating to the responsibilities of administrator A, the scope of services of administrator A (including provision of field kit 512 described hereinbelow, and screening of contractors C), provision of home inspection services, provision of expert witness services, limitation of liability of administrator A and responsibility for legal fees, prohibition of administrator A participating in bidding and negotiation phase, exclusion of a requirement of design services by administrator A, exclusion of the preparation or administration of construction documents by administrator A, and requirement of homeowner H to complete, and have contractor C complete, warranty validation form 395 and final warranty certificate 625 (best shown in FIG. 7); however, it should be recognized that any applicable provision may be incorporated into contract 514.

Upon execution of contract 514, field kit 512 is sent to homeowner H via step 510, wherein field kit 512 comprises terms and conditions of contract 514 between homeowner H and managing engineering firm administrator A, protective procedural safeguards 517, master flow chart 518, warranty validation form 395 and final warranty certificate 625. Additionally, administrator A provides further detail about project P of homeowner H in step 530, such as, for exemplary purposes only, adding project-specific materials and/or applicable code requirements. Administrator sends secure access code 525 to homeowner via step 520, wherein homeowner H can then access database 140 via step 540 to post project P on web site W, and to receive bids B from contractors C via step 550, wherein contractors C have previously been approved by administrator A via process 570 (best shown in detail in FIG. 2). After selecting contractor C in step 550, homeowner H and contractor C agree to undertake project P. Upon selection of contractor C, contractor C completes warranty validation form 395 (best shown in FIG. 6) in step 390, and homeowner H sends completed warranty validation form 395 to administrator A. Project P then commences via process 400 (best shown in FIG. 4).

Referring now more specifically to FIG. 4, selected project P commences in step 400, wherein homeowner H sends warranty validation form 395 to administrator A via step 600. Contractor C utilizes search engine 139 via step 405 to obtain current manufacturer installation specifications via step 407 for materials to be utilized, wherein contractor C commences work 610 thereafter. Upon completion of project P, contractor C signs affidavit 627 of final warranty certificate 625 (best shown in FIG. 7) via step 620, wherein contractor C affirms that all subcontractors SC have received payment so as to avoid placement of any liens on homeowner H by subcontractors SC. Upon completion of step 620, contractor C is paid by homeowner H in step 630 and homeowner H forwards final warranty certificate 625 to administrator A via step 640. Upon receipt of final warranty certificate 625, administrator A authenticates and returns same to homeowner H via step 650.

It is envisioned in an alternate embodiment that warranty certificate 625 could carry numerical indicia thereon for the purpose of controlling certificates 625 and identifying homeowners H to whom certificates 625 are issued. It is further envisioned that any such numerical indicia could be sequential.

It is envisioned in another alternate embodiment that warranty certificate 625 could comprise signature acknowledgment by contractor C to indicate receipt of partial payments.

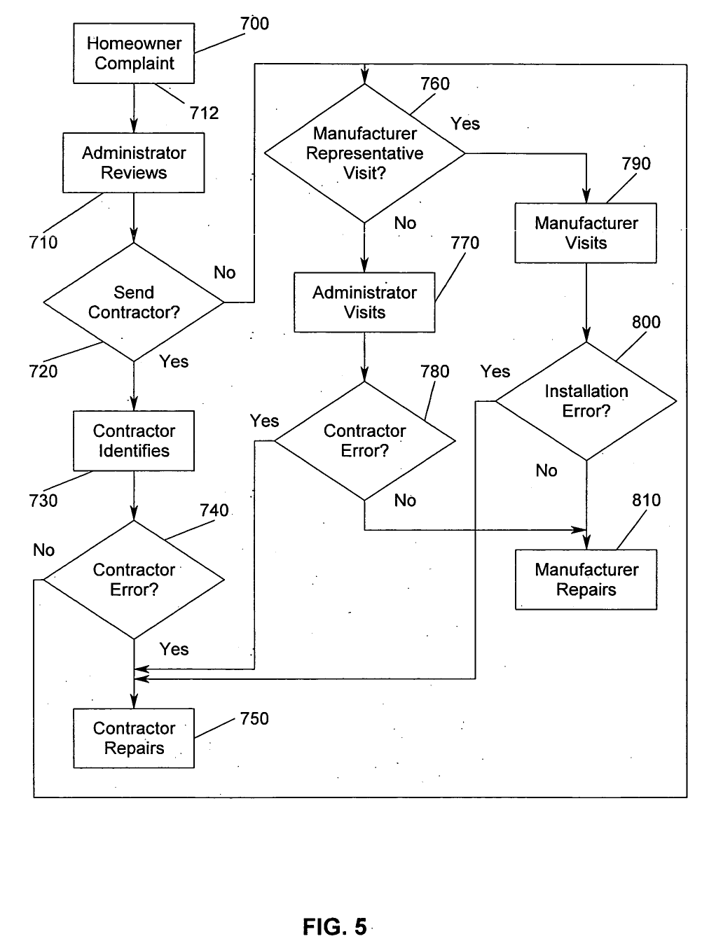

Referring now more specifically to FIG. 5, in the event of any complaints by homeowner H regarding work performed by contractor C, homeowner H files warranty complaint 712 with administrator A via step 700. Administrator A reviews complaint 712 in step 710 and determines in step 720 whether to send contractor C to project P for investigation. In step 730, contractor C investigates project P and determines whether he/she made an error, and, if so, contractor C corrects the error in step 750.

If contractor C determines that he/she was not at fault, administrator A determines in step 760 whether to request manufacturer's representative MR to visit project P to determine whether there is a problem with materials.

Manufacturer's representative MR visits homeowner H in step 790 to determine whether there was a defect in materials. If manufacturer's representative MR determines that there was an error in installation of materials in step 800, contractor C is required to perform project repairs via step 750. If manufacturer's representative MR determines that there was a defect in materials, then manufacturer M performs or contracts for repairs in step 810.

If administrator A determines that it is not necessary to send manufacturer's representative MR to review project P, administrator A visits project P in step 770. If administrator A determines that there was faulty work by contractor C in step 780, administrator A requires contractor C to commence repairs via step 750. If administrator A finds no problem with work performed by contractor C, administrator A contacts manufacturer M via step 810, requesting repair of defective materials.

It is anticipated in an alternate embodiment of the present invention that homeowner H might not require affidavit 627 to be signed by contractor C for projects P of minimal cost, such as, for exemplary purposes only, projects P smaller than a predetermined amount.

It is contemplated in another alternate embodiment of the present invention that administrator A might automatically visit project P upon completion to determine whether project P has been performed correctly and/or to the satisfaction of homeowner H.

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

What is claimed is:

1. A system for providing home remodeling, said system comprising:
at least one computer connected to at least one network; and
a project administrator comprising at least one database connected to said at least one network, said at least one database comprising data, said data selected from the group consisting of contractors, homeowners, projects submitted by said homeowners, bids for said projects by said contractors, and combinations thereof.

2. The system of claim 1, wherein said homeowners post requests for proposals on said database.

3. The system of claim 1, wherein said contractors submit said bids to said homeowners via posting on said database.

4. The system of claim 1, wherein said project administrator comprises a managing engineering firm.

5. The system of claim 4, wherein said managing engineering firm warrants work performed by said contractor.

6. The system of claim 4, wherein said managing engineering firm performs inspection of projects to determine failure of a product.

7. The system of claim 4, wherein said managing engineering firm approves said contractors and said homeowners based on contractor business information and homeowner personal information.

8. The system of claim 7, wherein said business information comprises data selected from the group consisting of references, financial statements, business complaint records, and combinations thereof.

9. The system of claim 7, wherein said homeowner personal information comprises data selected from the group consisting of references, credit bureau data, and combinations thereof.

10. The system of claim 1, further comprising a search engine tuned for selection of manufacturer's installation procedures.

11. The system of claim 1, wherein said homeowners are provided with a field kit, said field kit comprising terms and conditions of agreement between said homeowner and said managing engineering firm, protective procedural safeguards, warranty certificate, and master flow chart.

12. The system of claim 11, wherein said warranty certificate carries thereon a number in a sequence of numbers.

13. The system of claim 1, wherein said contractors are assigned a code indicator, wherein said code indicator is selected from a group consisting of field of service indicators, training indicators, experience indicators, and combinations thereof.

14. The system of claim 1, wherein said contractors agree to perform free repairs of any work involving a product that a representative of a manufacturer of said product has determined to be improperly installed.

15. A method of managing home remodeling, said method comprising the steps of:
a. obtaining first party information about a first party;
b. obtaining second party information about a second party;
c. said second party submitting at least one first proposal to said database; and
d. approving or rejecting first party access to said at least one first proposal in said database based upon said first party information.

16. The method of claim 15, wherein said at least one first proposal comprises a home remodeling project.

17. The method of claim 15, said method further comprising the step of:
said first party presenting a second proposal for said at least one first proposal.

18. The method of claim 17, said method further comprising the step of:
said second party accepting said second proposal wherein said first party conducts a project for said second party.

19. The method of claim 15, further comprising the step of:
selecting said first party information from the group consisting of references, financial statements, business complaint records, and combinations thereof.

20. The method of claim 15, further comprising the step of:
selecting said second party information from the group consisting of references, credit bureau data, and combinations thereof.

21. The method of claim 15, further comprising the step of:
providing a warranty to said second party.

22. The method of claim 15, further comprising the step of:
completing a warranty validation form.

23. The method of claim 22, wherein said warranty validation form comprises approval by said second party of said first party to perform said project.

24. The method of claim 15, further comprising the step of:
completing a final warranty certificate.

25. The method of claim 24, wherein said final warranty certificate comprises acceptance by said second party of work performed.

26. The method of claim 24, further comprising the step of making an affidavit by said first party that all subcontractors have been paid via said final warranty certificate.

27. The method of claim 24, further comprising the step of making an affidavit by said first party that all work has been performed to applicable standards via said final warranty certificate.

28. The method of claim 24, further comprising the step of making an affidavit by said first party that all work has been performed to material specifications and installation instructions via said final warranty certificate.

29. The method of claim 15, further comprising the step of:
a third party operating said database.

30. The method of claim 29, wherein said third party comprises a managing engineering firm.

31. The method of claim 29, further comprising the step of:
said third party warranting work done by said first party for said second party.

32. The method of claim 29, further comprising the step of:
said third party providing listings of code and safety requirements to said first party and said second party.

33. The method of claim 29, further comprising the step of:
said first party performing warranty work for said second party at the request of said third party.

34. A method of remodeling homes, said method comprising the step of:
a. administering home remodeling construction by utilizing a database in communication with a computer system, said computer system comprising at least one computer connected to at least one network, wherein said database comprises data, said data selected from the group consisting of contractors, homeowners, projects submitted by said homeowners, and combinations thereof.
